(19) United States
(12) Patent Application Publication
(10) Pub. No.: US 2026/0046080 A1
(43) Pub. Date: Feb. 12, 2026

(54) METHOD AND RELATED DEVICE FOR OBTAINING RESOURCE UNIT ALLOCATION INFORMATION IN WIRELESS COMMUNICATION SYSTEM

(71) Applicant: Realtek Semiconductor Corp., HsinChu (TW)

(72) Inventors: Chi-Mao Lee, HsinChu (TW); Hsin-Yu Kuo, HsinChu (TW); Hsin-Chih Huang, HsinChu (TW)

(73) Assignee: Realtek Semiconductor Corp., HsinChu (TW)

(21) Appl. No.: 18/801,584

(22) Filed: Aug. 12, 2024

(30) Foreign Application Priority Data
Aug. 14, 2023 (TW) 112130403

(51) Int. Cl. H04L 5/00; H04L 1/00; H04W 72/0453

(52) U.S. Cl. CPC H04L 5/0048; H04L 1/0057; H04W 72/0453

(57) ABSTRACT

A method for a station to obtain resource unit allocation information, includes: receiving a first data unit, obtaining resource allocation information corresponding to the first data unit and obtaining a format description of a common field in a first signal field of the first data unit; receiving a second data unit, obtaining a format description of a common field in a first signal field of the second data unit; when the format descriptions of the common fields of the two data units are identical, comparing bits of the common fields between the two data units; and when the bits of the common fields of the two data units are identical, using the resource allocation information corresponding to the first data unit to parse a user-specific field of the first signal field of the second data unit, and accordingly configuring the station.

### BACKGROUND OF THE INVENTION

### 1. Field of the Invention

The present invention relates to wireless communication systems, and more specifically to a method and a related device for obtaining resource unit allocation information in wireless communication systems.

### 2. Description of the Prior Art

In IEEE 802.11ax and IEEE 802.11be specifications, a station (STA) has to decode a common field in a high efficiency signal B field (HE-SIG-B) or an extremely high throughput signal field (EHT-SIG) of a downlink multi-user physical layer protocol data unit (PPDU) from an access point (AP), thereby determining resource allocation information, such as resource unit (RU) allocation and corresponding user block allocation. When a hardware processor searches for orthogonal frequency division multiple access (OFDMA), multi-user multiple-input multiple-output (MU-MIMO), and bandwidth combinations under different common fields in the HE-SIG-B or EHT-SIG, it often leads to significant computational resource consumption (i.e., MIPS consumption). Especially, in the EHT standard, due to the introduction of multi-resource unit (MRU) mechanism, the combination of RUs becomes more complex, requiring more computational resources to determine RU allocation information. Therefore, there is a need in the field for a method and mechanism to address the above-mentioned issue.

### SUMMARY OF THE INVENTION

In view of above, it is one object of the present invention to provide a parsing mechanism for common fields in wireless communication systems. In the present invention, consistency of multiple fields in a current data unit and a previous data unit will be checked to decide whether to skip decoding of a common field. In embodiments of the present invention, it will firstly be checked whether a format description, given by the U-SIG or the HE-SIG-A, which describing the common field in the EHT-SIG or the HE-SIG-B of a current data unit is identical to that of a previous data unit. If the format descriptions are identical, it will further be checked whether content of the common field in the EHT-SIG or the HE-SIG-B of the current data unit is exactly identical to that of the previous data unit. If the contents of the common fields are exactly identical, the decoding of the common field in the EHT-SIG or the HE-SIG-B of the current data unit will be skipped, directly proceeding to decoding of user-specific fields in the EHT-SIG or the HE-SIG-B of the current data unit. In this way, computational resources and time of the processor can be saved, allowing for better utilization of computational resources the processor and also improving a performance-to-power ratio of the processor.

According to one embodiment of the present invention, a method for use in a station of a wireless communication system to obtain resource unit allocation information is provided. The method comprises: receiving a first data unit from an access point of the wireless communication system, obtaining resource allocation information corresponding to the first data unit and obtaining a format description of a common field in a first signal field of the first data unit; receiving a second data unit and obtaining a format description of a common field in a first signal field of the second data unit; if the format description of the common field in the first signal field of the second data unit is identical to the format description of the common field in the first signal field of the first data unit, comparing bits in the common field in the first signal field of the second data unit with those of the first data unit; and if the bits in the common field in the first signal field of the second data unit are identical to the bits in the common field in the first signal field of the first data unit, utilizing the resource allocation information corresponding to the first data unit to parse a user-specific field corresponding to the station in the first signal field of the second data unit, and accordingly configuring the station.

According to one embodiment of the present invention, an apparatus for use in a station of a wireless communication system is provided. The apparatus comprises: a storage unit and a processing unit. The storage unit is configured to store information and program codes. The processing unit is configured to execute the program codes to perform operations of: receiving a first data unit from an access point of the wireless communication system, obtaining resource allocation information corresponding to the first data unit and obtaining a format description of a common field in a first signal field of the first data unit; receiving a second data unit and obtaining a format description of a common field in a first signal field of the second data unit; if the format description of the common field in the first signal field of the second data unit is identical to the format description of the common field in the first signal field of the first data unit, comparing bits in the common field in the first signal field of the second data unit with those of the first data unit; and if the bits in the common field in the first signal field of the second data unit are identical to the bits in the common field in the first signal field of the first data unit, utilizing the resource allocation information corresponding to the first data unit to parse a user-specific field corresponding to the station in the first signal field of the second data unit, and accordingly configuring the station.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a frame format and field relationships in IEEE 802.11be.

FIG. 2 illustrates a frame format and field relationships in IEEE 802.11ax.

FIG. 3 illustrates a flow chart of a common field parsing mechanism according to one embodiment of the present invention.

FIG. 4 illustrates a flow chart of a method for obtaining RU allocation information according to one embodiment of the present invention.

FIG. 5 illustrates a block diagram of a device for implementing the method of obtaining RU allocation information according to one embodiment of the present invention.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

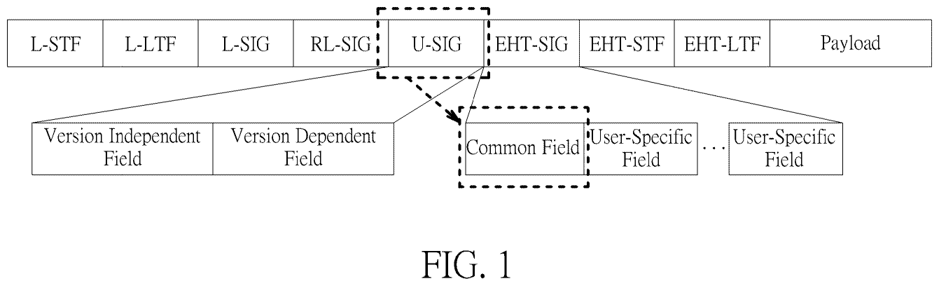

FIG. 1 illustrates a format of extremely high throughput (EHT) physical layer protocol data unit (PPDU) for IEEE 802.11be (i.e., Wi-Fi 7). As depicted, an EHT PPDU comprises legacy short training field (L-STF), legacy long training field (L-LTF), legacy signal field (L-SIG), repeated legacy signal field (RL-SIG), universal signal field (U-SIG), extremely high throughput signal field (EHT-SIG), extremely high throughput short training field (EHT-STF), extremely high throughput long training field (EHT-LTF) and payload. The L-STF, L-LTF, L-SIG and RL-SIG are utilized for frame detection, synchronization and conveying essential information, such as modulation and coding scheme (MCS) and frame length. The U-SIG comprises several version independent fields. The version independent fields include a format description about a command field in the EHT-SIG. The EHT-SIG comprises a common field and multiple user-specific fields. The common field comprises common bits, cyclic redundancy check (CRC) bits and tail bits. The common field comprises resource allocation information associated with RU allocation. More specifically, the resource allocation information can include RU assignment and RU allocation, indicating a number of RUs the bandwidth is divided into, a frequency band each RU corresponds to, a number of tones/subcarriers each RU comprises, and which station each RU is allocated to. Through the common field, a station can also discern a number of user-specific fields for each content channel in the EHT-SIG field, and a length of each user-specific field, enabling the station to accurately decode its corresponding user-specific field. The user-specific fields are employed to respectively convey dedicated information to multiple users (i.e., multiple stations). The EHT-STF and the EHT-LTF are used for channel estimation in MIMO/OFDMA transmissions. To obtain resource allocation information, the station needs to decode the U-SIG, thereby discerning the format description of the common field. Based on the format description of the common field that is obtained by decoding the U-SIG, the station further decodes the common field to obtain the resource allocation information with the RU allocation. Subsequently, the station discerns formats of the user-specific fields and accordingly decodes the user-specific fields. In this manner, the station can configure (setup) based on the resource allocation information and the content of the user-specific field to accurately retrieve data in the payload.

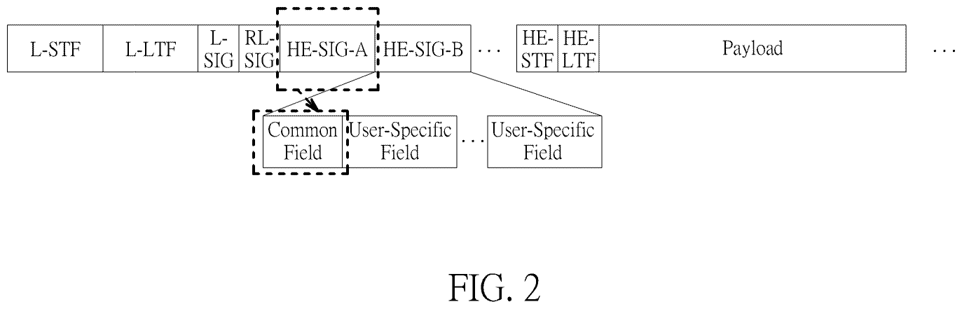

FIG. 2 illustrates a format of high efficiency (HE) multi-user (MU) PPDU for IEEE 802.11ax (i.e., Wi-Fi 6). As depicted, a HE MU PPDU comprises L-STF, L-LTF, L-SIG, RL-SIG, a high efficiency signal A field (HE-SIG-A), high efficiency signal B field (HE-SIG-B), high efficiency short training field (HE-STF), high efficiency long training field (HE-LTF), and payload. The L-STF, L-LTF, L-SIG, and RL-SIG are utilized for frame detection, synchronization and conveying essential information, such as modulation and coding scheme (MCS) and frame length. The HE-SIG-A comprises a format description about a common field in the HE-SIG-B field. The HE-SIG-B comprises the common field and multiple user-specific fields. The common field includes common bits, CRC bits and tail bits. The common field comprises resource allocation information associated with RU allocation. More specifically, the resource allocation information can include RU assignment and RU allocation, indicating a number of RUs the bandwidth is divided into, a frequency band each RU corresponds to, a number of tones/subcarriers each RU comprises, and which station each RU is allocated to. Through the common field, a station can also discern a number of user-specific fields for each content channel in the HE-SIG-B and a length of each user-specific field, enabling the station to accurately decode its corresponding user-specific field. The user-specific fields are employed to respectively convey dedicated information to multiple users (i.e., multiple stations). The HE-STF and HE-LTF are used for channel estimation in MIMO/OFDMA transmissions. To obtain resource allocation information, the station needs to decode the HE-SIG-A, thereby discerning the format description of the common field. Based on the format description of the common field that is obtained by decoding the HE-SIG-A, the station further decodes the common field to obtain the resource allocation information with the RU allocation. Subsequently, the station discerns formats of the user-specific fields and accordingly decodes the user-specific fields. In this manner, the station can configure (setup) based on the resource allocation information and the content of the user-specific field to accurately retrieve data from the payload.

As can be understood from the above, regardless of whether it is in the IEEE 802.11ax or IEEE 802.11be standards, decoding of the common field is a crucial step when receiving information. Hence, the present invention provides an improved flow for decoding of the common field.

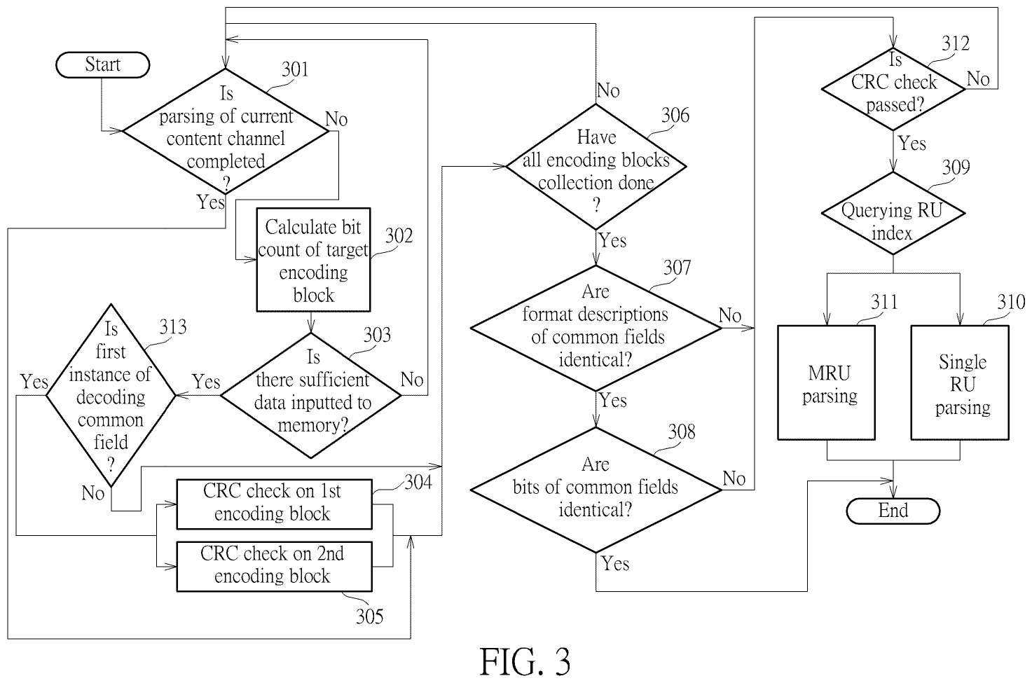

FIG. 3 illustrates a flow for decoding of a common field according to one embodiment of the present invention. The flow is specifically for the decoding of the common field of a content channel and comprises (but is not limited to) three stages: a parsing stage, a repeatability determination stage, and an RU allocation parsing stage. Upon completing the parsing stage, the flow transitions to the repeatability determination stage. Based on a result of the repeatability determination stage, the flow decides whether to proceed to the RU allocation parsing stage.

The parsing stage commences from step 301 and ends at step 306. The main function of the parsing stage is to determine whether content of the common field within the content channel has been fully received and to decode it once the content is fully received. At step 301, it is determined whether parsing of a current content channel is completed. If yes, the flow jumps to step 306; if not, the flow proceeds to step 302. At step 302, a bit count of a target encoding block is calculated. Upon completion of step 302, the flow proceeds to step 303. At step 303, it is checked whether there is sufficient data inputted to the memory. If yes, the flow proceeds to step 313; if not, the flow returns back to step 301. At step 313, it is determined whether this is a first instance of decoding the common field. Specifically, it is checked at step 313 whether a previous decoding result of a common field (of a previous data unit) has been stored (e.g., cached) in the system. If this is the first instance of decoding the common field (i.e., no decoding result of a common field has been stored in the system), it implies that subsequent steps cannot utilize or reference the previous decoding result of the common field. Thus, the process proceeds to steps 304 and 305. On the other hand, if this is not the first instance of decoding the common field (i.e., the previous decoding result of the common field has been stored in the system), the flow advances to step 306.

At step 304, a CRC operation is performed on a first encoding block of content of the common field (by checking the CRC bits within the first encoding block). At step 305, the CRC operation is performed on a second encoding block of the content of the common field (by checking the CRC bits within the second encoding block). In this embodiment, a content channel comprises two encoding blocks. Only when both the first encoding block and the second encoding block pass the CRC operation, the flow proceeds to step 306. At step 306, it is determined whether all encoding blocks has been checked. If yes, the flow proceeds to step 307; if not, the flow returns back to step 301.

Once the flow proceeds to step 307, meaning that the flow enters the repeatability determination stage. In this stage, the format description recorded in the U-SIG (or the HE-SIG-A) of the current data unit, which is associated with the common field in the EHT-SIG (or the HE-SIG-B) of the current data unit, is compared to that of the previous data unit, wherein the current data unit and the previous data unit can be downlink EHT PPDUs or downlink HE MU PPDUs. The format descriptions of the common fields in the EHT-SIG (or the HE-SIG-B) of the current and previous data units are obtained by decoding bits in the U-SIG (or the HE-SIG-A) in the current and previous data units, respectively. If the format descriptions are identical, the flow proceeds to step 308; if they are different, the flow proceeds to step 312. Specifically, at step 307, it is checked whether the numbers of content channels in the EHT-SIG (or the HE-SIG-B) of the current and previous data units are identical, and checked whether bit counts of the common fields in the EHT-SIG (or the HE-SIG-B) of the current and previous data units are identical, so as to determine whether the format descriptions are identical.

If the format descriptions are identical, the flow proceeds to step 308, thereby to further compare consistency between the common fields in the EHT-SIG (or the HE-SIG-B) of the current and previous data units. If it is determined through the format descriptions of the common fields in the EHT-SIG (or the HE-SIG-B) obtained from the U-SIG (or the HE-SIG-A) that there is inconsistency between the format descriptions of the common fields in the EHT-SIG (or the HE-SIG-B), the flow proceeds to step 312.

At step 308, the content of the common field in the EHT-SIG (or the HE-SIG-B) of the current data unit is compared bit-by-bit with the content of the common field in the EHT-SIG (or the HE-SIG-B) of the previous data unit. Specifically, at step 308, the common bits and the CRC bits of the common fields in the EHT-SIG (or the HE-SIG-B) of the current and previous data units are compared. A match is only confirmed when all bits are identical. If all bits are identical, the RU allocation parsing stage will be skipped, directly completing the decoding of the common field. If not all the bits are identical, the flow advances to step 312. If, after step 308, the RU allocation parsing stage is skipped and the decoding of the common field is directly completed, it means that the station will use the decoding result of the EHT-SIG (or the HE-SIG-B) from the previous data unit to obtain resource allocation information. Accordingly, the user-specific field corresponding to the station in the EHT-SIG (or the HE-SIG-B) of the current data unit is parsed according to the obtained resource allocation information.

If there is a mismatch found at step 307 or step 308, the flow proceeds to step 312. At step 312, the CRC operation are performed to check the common bits in the common field of the EHT-SIG (or the HE-SIG-B) by using the CRC bits in the common field in the EHT-SIG (or the HE-SIG-B). If the CRC operation is passed, the flow proceeds to step 309; if not, the flow returns back to step 301. Since the common bits in the common field in the EHT-SIG (or the HE-SIG-B) of the previous data unit have already passed the CRC operation, a match at step 308 means that the common bits in the common field in the EHT-SIG (or the HE-SIG-B) of the current data unit will inevitably pass the CRC operation. Therefore, a CRC operation is only necessary when the mismatch is found at step 307 or at step 308. This approach saves time by eliminating the need for CRC operations for every data unit.

Upon entering step 309, the flow moves into the RU allocation parsing stage. Initially, an RU index is queried to determine whether current RU allocation given by the access point is of a single RU type or a multi-RU (MRU) type, that is, whether multiple RUs are allocated to the station. In addition, the RU index further defines a size of each RU (i.e., including how many subcarriers) and a position within a channel (i.e., occupying which frequency band). More specifically, at step 309, based on the format description of the common field in the EHT-SIG (or the HE-SIG-B), the common field in the EHT-SIG (or HE-SIG-B) is decoded to obtain the resource allocation information including the RU index. Additionally, using the RU index, it is further determined whether the RU allocation currently given by the access point is of the single RU type or the MRU type. In other words, at step 309, since the common bits of the common field in the EHT-SIG (or the HE-SIG-B) of the previous data unit differ from those of the current data unit (as determined at step 308), or the format descriptions differ (as determined at step 307), the common bits of the common field in the EHT-SIG (or HE-SIG-B) of the current data unit need to be decoded.

Based on the result, the flow either proceeds to step 310 for single RU parsing, or to step 311 for MRU parsing. At both steps 310 and 311, the resource allocation information corresponding to the current data unit is employed for parsing the user-specific field (corresponding to the station) in the EHT-SIG (or the HE-SIG-B) of the current data unit, thereby obtaining information about available RUs in the channel, and configuring the station accordingly. After step 310 or 311, the decoding of the common field is finished. That is, after entering step 309, the decoding result of the common field in the EHT-SIG (or the HE-SIG-B) of the current data unit are employed for obtaining the resource allocation information, subsequently configuring the station to parse the user-specific field, and retrieve information from a corresponding RU. As can be understood from above, a main feature of the present invention is that when the content of the common field in the EHT-SIG (or the HE-SIG-B) of the current data unit matches that of the previous data unit, the RU allocation parsing stage is skipped. The RU allocation information obtained from the previous data unit will be directly used to configure the station for subsequent data processing.

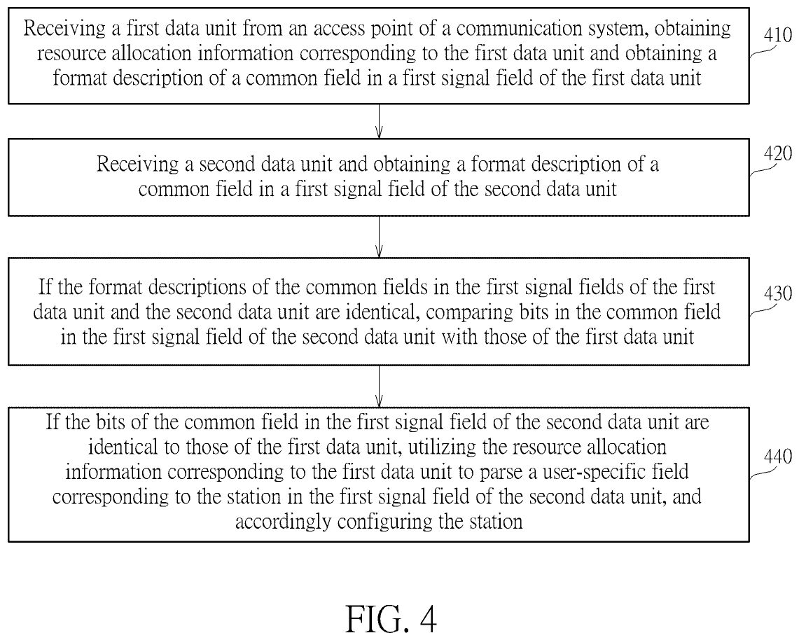

Based on the aforementioned embodiments, FIG. 4 illustrates a method for obtaining RU allocation information according to one embodiment of the present invention. As illustrated, the method includes a simplified flow as follows:

Step 410: receiving a first data unit from an access point of a wireless communication system, obtaining resource allocation information corresponding to the first data unit and obtaining a format description of a common field in a first signal field of the first data unit;

Step 420: receiving a second data unit and obtaining a format description of a common field in a first signal field of the second data unit;

Step 430: if the format description of the common field in the first signal field of the second data unit is identical to that of the first data unit, comparing bits in the common field in the first signal field of the second data unit with those of the first data unit; and

Step 440: if the bits of the common field in the first signal field of the second data unit are identical to those of the first data unit, utilizing the resource allocation information corresponding to the first data unit to parse a user-specific field corresponding to the station in the first signal field of the second data unit, and accordingly configuring the station.

Since principles and specific details of the aforementioned steps have already been elaborated upon through previous embodiments, further explanations are omitted here. However, please note that the above flow can be enhanced through the addition of extra steps, or by making appropriate modifications and adjustments, to better facilitate communication between access points and stations, and to improve data transmission performance.

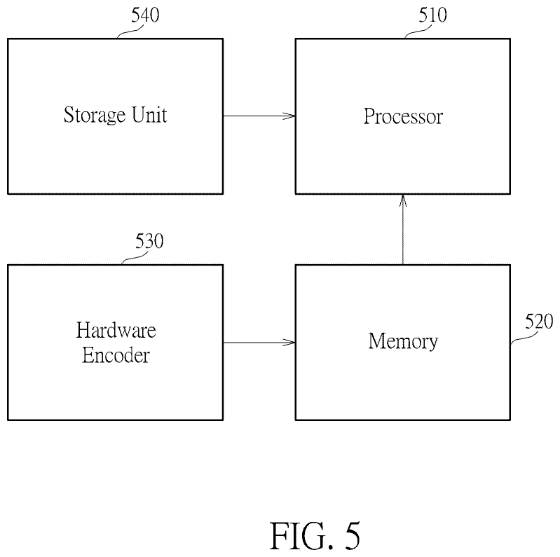

FIG. 5 illustrates a block diagram of a device for implementing the method of present invention. As depicted, a device 500 comprises a processor 510, a memory 520, a hardware decoder 530, and a storage unit 540. In one embodiment, the device 500 can be deployed in a station and employed for processing EHT PPDUs or HE MU PPDUs received by the station. The storage unit 540 can be a non-volatile storage device, capable of storing program codes and essential information. The processor 510 is configured to execute the program codes to implement the method of obtaining the resource allocation information of the present invention. The hardware decoder 530 can be a Viterbi decoder or other types of decoders, which is configured to decode the U-SIG and the EHT-SIG of an EHT PPDU or the HE-SIG-A and the HE-SIG-B of a HE MU PPDU, so as to store decoding results in the memory 520. As mentioned above, the method of the present invention needs a comparison between the format descriptions of the common fields in the EHT-SIG (or the HE-SIG-B) of the previous and current data units, as well as a comparison of the contents of the common fields of the previous and current data units. Thus, the memory 520 is configured to store the format description of the common field in the EHT-SIG (or the HE-SIG-B) of the previous data unit and the content of the common field of the previous data unit, for being compared with subsequent data units. The processor 510 can decode output results generated by the hardware decoder 530 and perform resource allocation calculations.

In summary, the present invention provides a mechanism for repeatability checking of contents of common fields. If the contents of the common fields of consecutive data units are identical, the decoding of the common field of the current data unit is omitted. The method of the present invention is particularly effective when an access point adopts a static (wireless) resource allocation strategy. Under the static resource allocation strategy, the access point evenly divides bandwidth across each station, making RU allocations relatively static and meaning that the contents of the common fields are often identical. In such scenario, the processor of the station can initiate the decoding of user-specific fields earlier and enter a wait-for-interrupt state sooner (since the decoding of the common field is skipped). As a result, the processor has more time to remain in the power-saving mode to reduce the power consumption of the station, or to carry out lower-priority tasks, thereby optimizing the performance of the station.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system. ” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus for use in a station of a wireless communication system, comprising:
a storage unit, configured to store information and program codes;
a processing unit, configured to execute the program codes to perform operations of:
receiving a first data unit from an access point of the wireless communication system, obtaining resource allocation information corresponding to the first data unit and obtaining a format description of a common field in a first signal field of the first data unit;
receiving a second data unit and obtaining a format description of a common field in a first signal field of the second data unit;
if the format description of the common field in the first signal field of the second data unit is identical to the format description of the common field in the first signal field of the first data unit, comparing bits in the common field in the first signal field of the second data unit with bits in the common field in the first signal field of the first data unit; and
if the bits in the common field in the first signal field of the second data unit are identical to the bits in the common field in the first signal field of the first data unit, utilizing the resource allocation information corresponding to the first data unit to parse a user-specific field corresponding to the station in the first signal field of the second data unit, and accordingly configuring the station.

2. The apparatus of claim 1, wherein the processing unit is configured to execute the program codes to perform operations of:
decoding the bits in the common field in the first signal field of the second data unit to obtain resource allocation information corresponding to the second data unit, if the bits in the common field in the first signal field of the second data unit are not identical to the bits in the common field in the first signal field of the first data unit; and
utilizing the resource allocation information corresponding to the second data unit to parse the user-specific field corresponding to the station in the first signal field of the second data unit, thereby accordingly configuring the station.

3. The apparatus of claim 1, wherein the processing unit is configured to execute the program codes to perform operations of:
decoding the bits in the common field in the first signal field of the second data unit to obtain resource allocation information corresponding to the second data unit, if the format description of the common field in the first signal field of the second data is not identical to that of the first data unit; and
utilizing the resource allocation information corresponding to the second data unit to parse the user-specific field corresponding to the station in the first signal field of the second data unit, thereby accordingly configuring the station.

4. The apparatus of claim 1, wherein the processing unit is configured to execute the program codes to perform operations of:
decoding bits in a second signal field of the first data unit to obtain the format description of the common field in the first signal field of the first data unit; and
decoding bits in a second signal field of the second data unit to obtain the format description of the common field in the first signal field of the second data unit.

5. The apparatus of claim 4, wherein the first signal field is a high efficiency signal B field (HE-SIG-B) or an extremely high throughput signal field (EHT-SIG); and the second signal field is a high efficiency signal A field (HE-SIG-A) or a universal signal field (U-SIG).

6. The apparatus of claim 1, wherein the format descriptions of the common fields in the first signal fields of the first data unit and the second data unit comprise a bit count of the common field and a number of content channels of the first signal field.

7. The apparatus of claim 1, wherein the processing unit is configured to execute the program codes to perform operations of:
comparing common bits and cyclic redundancy check (CRC) bits of the common field in the first signal field of the second data unit with common bits and cyclic redundancy check (CRC) bits of the common field in the first signal field of the first data unit to determine whether the common bits and the CRC bits in the common fields in the first signal fields of the first data unit and the second data unit are exactly identical.

8. The apparatus of claim 1, wherein the resource allocation information corresponding to the first data unit and the second data unit at least indicates information associated with RU allocation.

9. The apparatus of claim 1, wherein the first data unit and the second data unit are downlink high efficiency multi-user physical layer protocol data units, or downlink extremely high throughput physical layer protocol data units.

10. A method for use in a station of a wireless communication system to obtain resource unit (RU) allocation information, comprising:
receiving a first data unit from an access point of the wireless communication system, obtaining resource allocation information corresponding to the first data unit and obtaining a format description of a common field in a first signal field of the first data unit;
receiving a second data unit and obtaining a format description of a common field in a first signal field of the second data unit;
if the format description of the common field in the first signal field of the second data unit is identical to the format description of the common field in the first signal field of the first data unit, comparing bits in the common field in the first signal field of the second data unit with bits in the common field in the first signal field of the first data unit; and
if the bits in the common field in the first signal field of the second data unit are identical to the bits in the common field in the first signal field of the first data unit, utilizing the resource allocation information corresponding to the first data unit to parse a user-specific field corresponding to the station in the first signal field of the second data unit, and accordingly configuring the station.

11. The method of claim 10, further comprising:
decoding the bits in the common field in the first signal field of the second data unit to obtain resource allocation information corresponding to the second data unit, if the bits in the common field in the first signal field of the second data unit are not identical to the bits in the common field in the first signal field of the first data unit; and
utilizing the resource allocation information corresponding to the second data unit to parse the user-specific field corresponding to the station in the first signal field of the second data unit, thereby accordingly configuring the station.

12. The method of claim 10, further comprising:
decoding the bits in the common field in the first signal field of the second data unit to obtain resource allocation information corresponding to the second data unit, if the format description of the common field in the first signal field of the second data is not identical to that of the first data unit; and
utilizing the resource allocation information corresponding to the second data unit to parse the user-specific field corresponding to the station in the first signal field of the second data unit, thereby accordingly configuring the station.

13. The method of claim 10, wherein the step of obtaining the format description of the common field in the first signal field of the first data unit and obtaining the format description of the common field in the first signal field of the second data unit comprises:
decoding bits in a second signal field of the first data unit to obtain the format description of the common field in the first signal field of the first data unit; and
decoding bits in a second signal field of the second data unit to obtain the format description of the common field in the first signal field of the second data unit.

14. The method of claim 13, wherein the first signal field is a high efficiency signal B field (HE-SIG-B) field or an extremely high throughput signal field (EHT-SIG) field; and the second signal field is a high efficiency signal A field (HE-SIG-A) field or a universal signal field (U-SIG).

15. The method of claim 10, wherein the format descriptions of the common fields in the first signal fields of the first data unit and the second data unit comprise a bit count of the common field and a number of content channels of the first signal field.

16. The method of claim 10, wherein the step of comparing the bits in the common field in the first signal field of the second data unit with those of the first data unit comprises:
comparing common bits and cyclic redundancy check (CRC) bits in the common field in the first signal field of the second data unit with common bits and cyclic redundancy check (CRC) bits of the common field in the first signal field of the first data unit to determine whether the common bits and the CRC bits in the common fields in the first signal fields of the first data unit and the second data unit are exactly identical.

17. The method of claim 10, wherein the resource allocation information corresponding to the first data unit and the second data unit at least indicates information associated with RU allocation.

18. The method of claim 10, wherein the first data unit and the second data unit are downlink high efficiency multi-user physical layer protocol data units, or downlink extremely high throughput physical layer protocol data units.
